(19) United States
(12) Patent Application Publication
(10) Pub. No.: US 2025/0104486 A1
(43) Pub. Date: Mar. 27, 2025

(54) METHOD AND APPARATUS FOR ESTIMATING OCCURRENCE LOCATION OF EVENT OF INTEREST, AND COMPUTING DEVICE

(71) Applicant: Aktiebolaget SKF, Göteborg (SE)

(72) Inventors: Xiaoyuan MA, Shanghai (CN); Hongwei WU, Shanghai (CN); Xing YI, Shanghai (CN); Xiaotao YUAN, Shanghai (CN); Liang ZHANG, Zou Cheng (CN)

(21) Appl. No.: 18/889,559

(22) Filed: Sep. 19, 2024

(30) Foreign Application Priority Data
Sep. 26, 2023 (CN) 202311263055.7

(51) Int. Cl. G07C 5/02; G07C 5/00

(52) U.S. Cl. CPC G07C 5/02; G07C 5/008

(57) ABSTRACT

A method and apparatus for estimating an occurrence location of an event of interest, and computing devices. The method may include: determining a location determination delay time period based on a first time point at which the event of interest occurs and a second time point at which motion information is acquired earliest; acquiring pieces of motion information at sampling time points with a predetermined sampling interval, each piece of motion information includes a motion speed, a motion direction, and a location of the moving vehicle at a respective sampling time point; determining a motion change rate of the moving vehicle based on the pieces of motion information; and estimating the occurrence location of the event of interest based on the motion information at an ordinal first one sampling time point of the sampling time points, the motion change rate, and the location determination delay time period.

### CROSS-REFERENCE TO RELATED APPLICATION

This application claims priority to Chinese Application No. 202311263055.7, filed Sep. 26, 2023, the entirety of which is hereby incorporated by reference.

### FIELD

The present application relates to the field of computer technology, and more particularly, to a method and apparatus for estimating an occurrence location of an event of interest, and a computing device.

### BACKGROUND

Energy-limited (i.e., battery-powered) sensor devices generally have the advantages of ease of deployment and low maintenance costs, so it is a trend to apply them to various fields to achieve predictive maintenance. For example, in a moving vehicle (e.g., a train, a car, an aircraft, etc.), it is often necessary to provide various sensor devices to detect states of various components in the moving vehicle or internal or external environmental state of the moving vehicle, etc. Through monitoring various states in real time, predictive protection can be achieved before failure occurs.

The sensor device in the moving vehicle may sense an event of interest (e.g., a large vibration) and determine an occurrence location of the event of interest, which may thus be used to determine how next decisions and processing should be made for the event of interest. If, for example, significant vibrations are sensed during the travel of a train, subsequent surveying and check of relevant track area may be taken in accordance with the determined occurrence location.

Thus, it can be seen that accurately determining the occurrence location of the event of interest is important for the running performance and safety of the moving vehicle. Therefore, there is a need for a solution capable of accurately determining the occurrence location of the event of interest.

### SUMMARY

According to an aspect of the present application, there is provided a method for estimating an occurrence location of an event of interest in a moving vehicle, comprising: determining a location determination delay period based on a first time point at which the event of interest occurs and a second time point at which motion information is acquired earliest; acquiring a plurality of pieces of motion information at a plurality of sampling time points with a predetermined sampling interval, wherein each piece of motion information comprises a motion speed, a motion direction, and a location of the moving vehicle at a respective sampling time point; determining a motion change rate of the moving vehicle based on the plurality of pieces of motion information; and estimating the occurrence location of the event of interest based on the motion change rate and the location determination delay time period.

According to another aspect of the present application, there is provided an apparatus for estimating an occurrence location of an event of interest in a moving vehicle, comprising: a sensing module for sensing data related to the event of interest in a low power consumption mode and transmitting an indication to a processing module when the event of interest is sensed; a motion detection module for sampling motion information of the moving vehicle at a predetermined time interval after start-up is completed; and a processing module for determining, based on the indication, a first time point at which the event of interest occurs, and starting up the motion detection module and acquiring the motion information from the motion detection module in response to determining that the event of interest occurs, and determining a second time point at which the motion information is acquired earliest, wherein the processing module is further configured to perform the method as described above.

According to another aspect of the present application, there is provided a computing device comprising: a processor; and a memory having stored thereon a computer program which, when executed by the processor, causes the processor to perform the method as described above.

According to the solution for estimating the occurrence location of the event of interest in the moving vehicle of the present application, by estimating the occurrence location of the event of interest based on the plurality of pieces of motion information acquired after the start-up of the motion detection module instead of directly taking the occurrence location in the first piece of motion information acquired after the start-up of the motion detection module as the occurrence location of the event of interest, the occurrence location of the event of interest can be determined more accurately while satisfying the requirement of low power consumption of the sensor device, and no other hardware setting needs to be additionally set, which is more convenient and cost-effective.

### BRIEF DESCRIPTION OF THE DRAWINGS

In order to more clearly illustrate the technical solutions in the embodiments of the present application or the prior art, the following will simply introduce the accompanying drawings which are needed in the description of the embodiments of the present application or the prior art, and it is obvious that the accompanying drawings in the following description are only some of the embodiments described in the present application, and other drawings can be obtained by those skilled in the art according to these drawings of the embodiments of the present application.

FIG. 1A shows a schematic diagram of a deviation between a true occurrence location of an event of interest and a location provided by the motion detection module.

FIG. 1B shows a schematic diagram of an application scenario in which the occurrence location of the event of interest is estimated.

FIG. 2 is a flow diagram illustrating a method for estimating an occurrence location of an event of interest in a moving vehicle according to an embodiment of the present application.

FIG. 3 shows a schematic diagram of a plurality of pieces of motion information detected by the motion detection module at a plurality of sampling time points.

FIG. 4 is a schematic diagram of FIG. 3 with the addition of a plurality of selected time points.

FIG. 5 shows a flow diagram of an iteration calculation process without acquiring a motion direction from a geographic information system.

FIG. 6 shows a flow diagram of the iteration calculation process in a case where the motion direction is acquired from a geographic information system.

FIG. 7 shows an algorithmic flow diagram of the iteration calculation process.

FIG. 8 illustrates a block diagram of a computing device according to an embodiment of the present application.

### DETAILED DESCRIPTION

A clear and complete description will be made below of the technical solutions in the embodiments of the present disclosure in conjunction with the accompanying drawings in the embodiments of the present disclosure. Apparently, the described embodiments are only embodiments of a part of the present disclosure, rather than all of the embodiments. Based on the embodiments in the present disclosure, all other embodiments obtained by those of ordinary skill in the art without requiring inventive labor, belong to the scope of protection of the present disclosure.

A sensor device in a moving vehicle may include a sensing module (e.g., a sensing assembly and circuitry thereof) having a sensing function and a motion detection module (e.g., a GPS/GNSS module), for sensing an occurrence of an event of interest and detecting a motion state of the moving vehicle, which may be used to determine the occurrence location of the event of interest.

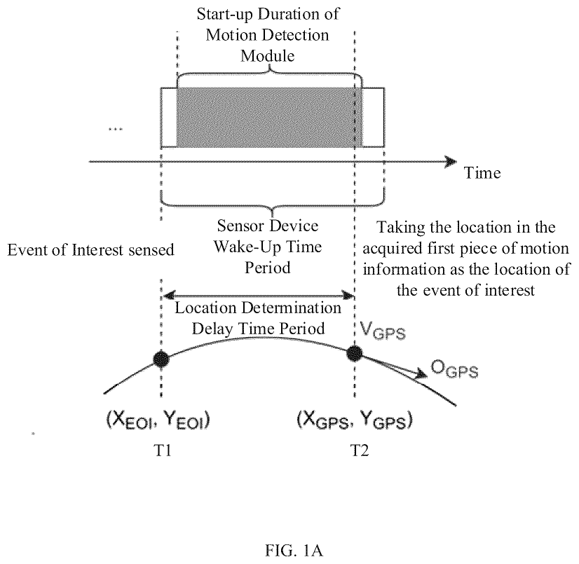

In order to save energy consumption, the remaining modules (e.g., processing module) in the sensor device, except for the sensing module maintaining normal sensing operation and operating in a low power consumption mode, are generally in sleep state, and the motion detection module (e.g., GPS/GNSS module) is generally in power-off state due to its relative large power consumption. Once the sensing module detects an event of interest, the remaining modules in the sensor device, such as the processing module, are woken up (referred to herein as the sensor device being woken up), thereby activating or triggering the motion detection module to provide location information, typically absolute location information, such as longitude and latitude, as the occurrence location of the detected event of interest (EOI). However, starting (especially cold starting) the motion detection module typically takes a long time (e.g., a start-up duration is at least tens of seconds), which means that upon the sensing module senses the event of interest, the motion detection module does not immediately provide location information, and the provided location information is where the moving vehicle is located after the start-up duration of the motion detection module, but not where the event of interest actually occurs. For example, in the case where the vehicle is a train, the speed of which is typically above 150 km/h, and the location indicated in the location information provided by the motion detection module may be far from the actual occurrence location of the EOI. For example, FIG. 1A shows a schematic diagram in which the actual occurrence location of the EOI (X_{EOI}, Y_{EOI}) is largely deviated from the location provided by the motion detection module (X_{GPS}, Y_{GPS}). It is shown in FIG. 1A that there is a small difference between the time point T1 when an event of interest is sensed to wake up the sensor device (e.g., processing module) and the time point when the motion detection module is triggered to start up (white area in the figure), and that there is also a small difference between the time point when the sensor device (e.g., processing module) enters the sleep state again and the time point T2 when the starting-up of the motion detection module is finished (able to send the motion information) (white area in the figure). These small differences are negligible in subsequent calculations.

If the actual occurrence location of the EOI (X_{EOI}, Y_{EOI}) deviates too much from the location provided by the motion detection module (X_{GPS}, Y_{GPS}), it may have a certain impact. For example, if (X_{GPS}, Y_{GPS}) in FIG. 1A is taken as the occurrence location of the event of interest, but the EOI actually occurs at (X_{EOI}, Y_{EOI}) in a case where the train is greatly vibrating when traveling as described above, this leads to a great misleading and inconvenience to survey or check the relevant area on the track.

In summary, since the start-up procedure (especially cold start-up) of the motion detection module (e.g., GPS/GNSS module) typically takes a relatively long time (e.g., at least tens of seconds), and then the location indicated by the location information provided by the motion detection module is not the actual occurrence location of the event of interest. In some solutions, the motion detection module may be made to operate in the sleep state (instead of the power-off state) when it is not necessary to detect a motion state (and thus may start up faster) at the expense of energy consumption. Embodiments of the present application thus provide a solution for more efficiently and accurately determining the occurrence location of the event of interest.

FIG. 1B shows a schematic diagram of an application scenario in which the occurrence location of the event of interest is estimated. The application scenario involves a sensor device 10 and optionally a local computing device 20 and/or a cloud computing device 30 (e.g. a cloud server with data processing capabilities, etc.).

The sensor device 10 is mounted in a moving vehicle and, as shown in FIG. 1B, may include a sensing module 110 and a motion detection module 120, and optionally a processing module 130. For example, if the sensor device has processing functionality, the sensor device 10 may further comprise the processing module 130 (and accordingly may comprise a storage module (e.g. a memory) for storing processing-related data). If the sensor device 10 does not have the processing functionality, the sensor device 10 may not include the processing module 130 and may communicate with another computing device having the processing capabilities, either locally or in the cloud, to send its data to those computing devices for processing. The mentioned computing device may be a server (a local server, a remote server, or a cloud server, etc.) or various terminal devices (for example, a mobile device, a personal computer, a digital personal assistant, etc.), etc. to communicate with the sensor device 10 to acquire various data.

The processing module in the sensor device 10 may be implemented in a dedicated hardware-based system (e.g., a general purpose processor, a digital signal processor (DSP), an application specific integrated circuit (ASIC), an off-the-shelf programmable gate array (FPGA) or other programmable logic device, discrete gate or transistor logic, discrete hardware components) that performs specified functions or operations, or may be implemented in a combination of dedicated hardware and computer instructions.

The sensing module 110 is a component of the sensor device 10 for implementing a sensing function, such as a sensor component body and its associated circuitry, such as a vibration sensor or temperature sensor and its peripheral circuitry, which typically has lower power consumption and remains active at all times to capture the event of interest in real time. The sensing module, upon capturing the event of interest, sends an indication to the processing module in the sensor device 10 (or an external computing device) so that the processing module (or the external computing device) can determine a first time point (T1) at which the event of interest occurs (e.g., the value of the sensed data satisfies a threshold condition) based on the indication. For example, the first time point may be the time point at which the indication is received by the processing module (or the external computing device).

The motion detection module 120 is a component of the sensor device 10 for enabling detection of a motion state, such as a GPS/GNSS module, which typically has a higher power consumption and is typically inactive (i.e., in power-off state), is only activated after a triggering operation in response to the processing module (this activation time is relatively long) for reducing power consumptions. The motion detection module 120 is configured to sample the motion information of the moving vehicle at predetermined time intervals (typically 1 second) after the start-up is complete.

In the case where the occurrence location of the event of interest is estimated by the sensor device 10, the processing module 130 is generally in a low power consumption mode such as a sleep mode, and is woken up to start operating after the indication indicating the occurrence of the event of interest is received from the sensing module 10, which can save power consumption and thereby prolong usage time. The processing module 130 may determine the first time point at which the indication is received, and in response to determining that the event of interest occurs, activate or trigger the motion detection module 120 and acquire motion information at various sampling time points from the motion detection module 120 after the start-up of the motion detection module is completed. The processing module 130 may determine a second time point (T2) at which the first piece of motion information is acquired. In addition, the processing module 130 may estimate the occurrence location of the event of interest using a solution as will be described later in detail according to the determined first time point, the second time point, and the obtained pieces of motion information sampled by the motion detection module at a plurality of sampling time points. The estimated location is relatively close to the actual location of the event of interest. The motion detection module is in the power-off state before receiving a start-up signal from the processing module, so the power consumption can also be saved.

To further conserve power consumption, the motion detection module 120 in the sensor device 10 may be powered off again when the occurrence location has been estimated for the present event of interest and no new event of interest has occurred, e.g., the processing module may re-enter the sleep state to wait for the indication from the sensing module of the occurrence of a new event of interest to wake up, while the motion detection module may be turned off directly to wait for the trigger or activation signal from the processing module or an external computing device.

Similarly, a computing device separate from the sensor device 10 may also acquire the above-described indication from the sensing module of the sensor device 10 and determine the first time point at which the indication is received based on the indication, and in response to determining that the event of interest occurred, activate or trigger the motion detection module 120 of the sensor device 10 and acquire motion information at respective sampling time points from the motion detection module 120 after the start-up of the motion detection module 120 is completed. The computing device may determine a second time point at which the first piece of motion information is acquired. Then, the occurrence location of the event of interest may be estimated using a solution as will be described in detail later on from the determined first time point, the second time point, and the obtained pieces of motion information sampled by the motion detection module at a plurality of sampling time points.

When the sensor device 10 includes the processing module and there is also the computing device in communication with the sensor device 10 and independent of the sensor device 10, the processes described above for the processing module 130 may be performed only at the processing module in the sensor device 10 or only at the computing device, or may be performed jointly by the processing module in the sensor device and the computing device, and the present application is not limited in this respect.

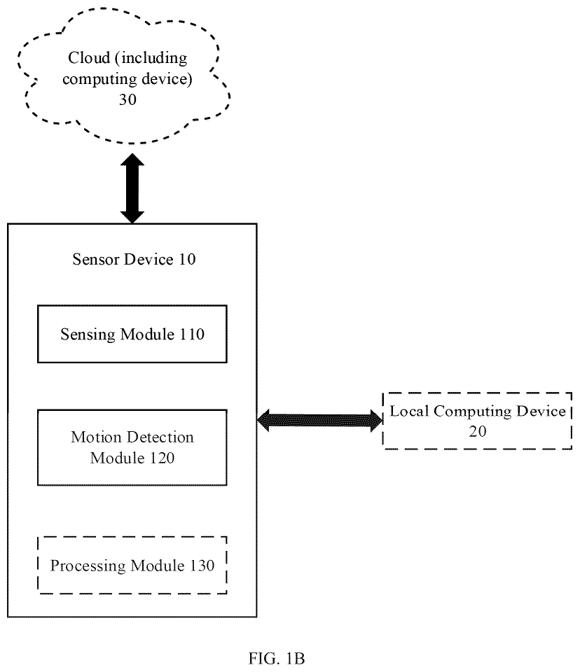

FIG. 2 is a flow diagram illustrating a method for estimating an occurrence location of an event of interest in a moving vehicle according to an embodiment of the present application. The method may be performed by the processing module in the sensor device 10 as shown in FIG. 1B or the computing device 20 (e.g., the cloud) independent of the sensor device 10 or by both.

As shown in FIG. 2, in step S210, a location determination delay time period is determined based on a first time point at which an event of interest occurs and a second time point at which motion information is acquired earliest.

For example, the sensing module (sensing component) in the sensor device may send an indication to the processing module or the computing device 20 indicating that the event of interest occurs (e.g., the temperature exceeds a threshold), and the processing module or the computing device may determine a time point (first time point) at which the event of interest occurred based on the indication. The processing module or computing device may then activate or trigger the motion detection module in the sensor device to start, and after the start-up duration of the motion detection module has elapsed, the motion detection module may start to perform motion information acquisition and send the motion information to the processing module or computing device, so the processing module or computing device may determine a second time point at which the first piece of motion information is acquired from the motion detection module. Since the communication time between the respective modules is negligibly short, the first time point may correspond to the actual occurrence time point of the event of interest and the second time point may correspond to the time point at which the processing module or the computing device 20 is able to determine the occurrence location of the event of interest, and thus the time period between the first time point and the second time point is referred to as the location determination delay time period.

In step S220, a plurality of pieces of motion information at a plurality of sampling time points with a predetermined sampling interval are acquired, where each piece of motion information includes a motion speed, a motion direction, and a location of the moving vehicle at a respective sampling time point.

For example, the motion detection module, after the start-up is completed, may acquire motion information at a plurality of sampling time points at a predetermined sampling interval (denoted as Tᵢₙₜₑᵣᵥₐₗ) to obtain a plurality of pieces of motion information, and each piece of motion information includes a motion speed, a motion direction, and a location of the moving vehicle at a respective sampling time point. Further, each piece of motion information may further include time information corresponding to a respective sampling time point. The processing module or computing device 20 may obtain such motion information.

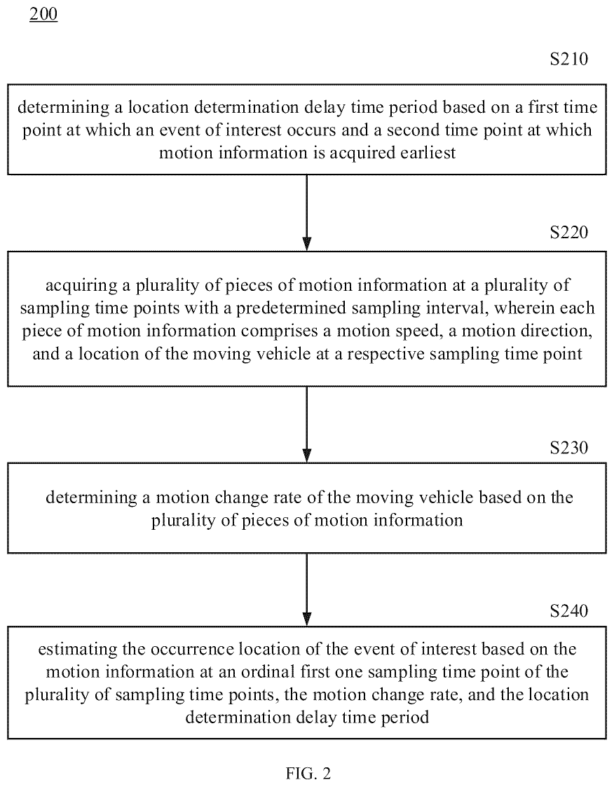

For example, FIG. 3 shows a schematic diagram of a plurality of pieces of motion information detected by the motion detection module at a plurality of sampling time points. In FIG. 3, point A represents the occurrence location (X_{EOI}, Y_{EOI}) of the event of interest, which is unknown and needs to be estimated, points G1, G2, . . . , GN represent a number of N sampling time points after the start-up of the motion detection module is completed, respectively, the motion information sampled at each sampling time point can be represented as (X_{GPSi}, Y_{GPSi}, V_{GPSi}, O_{GPSi}) and optionally time information, respectively, where i is an integer greater than or equal to 1 and less than or equal to N, X_{GPSi}, Y_{GPSi} are coordinates of the location at the i-th sampling time point, e.g., longitude and latitude coordinates, V_{GPSi} is the motion speed at the i-th sampling time point, and O_{GPSi} is the motion direction at the i-th sampling time point, represented by an included angle with respect to the earth's true north direction.

Furthermore, the motion direction may not be detected by a motion detection module, but may be provided by a geographic information system (GIS). The geographic information system is typically combined with a cloud service, so when the method shown in FIG. 2 is performed at a computing device in the cloud (e.g., a cloud server), the motion direction can be obtained directly from the geographic information system without the motion detection module in the sensor device acquiring the motion direction, i.e., the computing device in the cloud (e.g., a cloud server) acquires the motion speed and the location of the moving vehicle at each sampling time point from the motion detection module and acquires the motion direction of the moving vehicle at each sampling time point from the geographic information system.

In step S230, a motion change rate of the moving vehicle is determined based on the plurality of pieces of motion information.

For example, the motion change rate may include at least one of a motion speed change rate and a motion direction change rate.

In step S240, the occurrence location of the event of interest is estimated based on the motion information at an ordinal first sampling time point (a first one, the one with the earliest sampling time point) of the plurality of sampling time points, the motion change rate, and the location determination delay time period.

During the start-up of the motion detection module (a duration substantially the same as that of the location determination delay time period), the motion change rate of the moving vehicle may be used to estimate the motion change during said location determination delay time period, and in turn may be used to estimate the occurrence location of the event of interest, based on an assumption that the motion change rate of the moving vehicle does not change drastically during this start-up duration, i.e. remains substantially constant.

For example, a plurality of selected time points that are within the location determination delay time period may be determined based on the predetermined sampling interval (Tᵢₙₜₑᵣᵥₐₗ), e.g. by dividing the duration of the location determination delay time period by the duration of the predetermined sampling interval (Tᵢₙₜₑᵣᵥₐₗ) and rounding down, e.g. by the function floor ((T2-T1)/Tᵢₙₜₑᵣᵥₐₗ), as the quantity of selected time points. Then, based on the motion information at the ordinal first sampling time point (e.g., G1 point shown in FIG. 3) of the plurality of sampling time points, the motion change rate, and the predetermined sampling interval, an estimated location at each selected time point may be determined iteratively, in which the iteration starts from a selected time point (e.g., a time point that deviates from G1 point shown in FIG. 3 by the predetermined sampling interval) of the plurality of selected time points that is closest in time to the ordinal first sampling time point. Then, the estimated location at the selected time point of the plurality of selected time points that is farthest in time from the first sampling time point is taken as the estimated location at which the event of interest occurs.

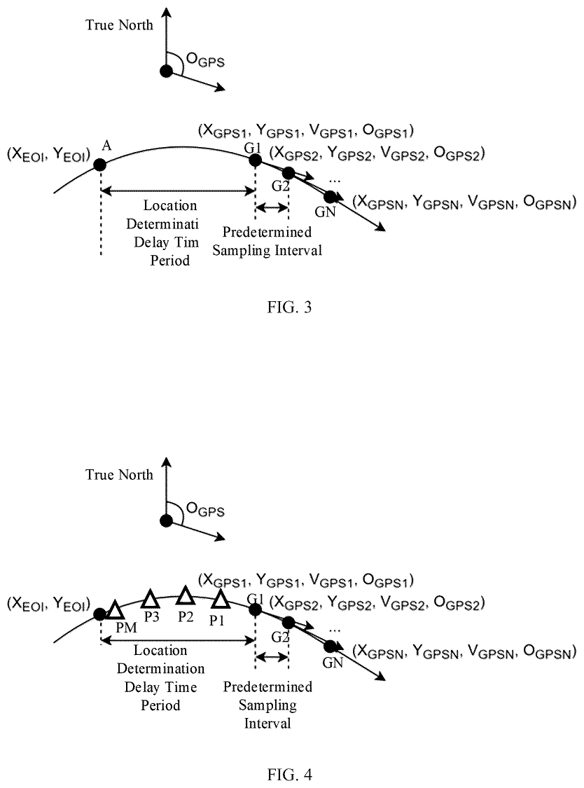

For example, FIG. 4 is a schematic diagram based on FIG. 3 with the selected points in time added. In the figure, a number M of selected time points (P1, P2, . . . , PM) are within the location determination delay time period, where the point P1 corresponds to the selected time point closest in time to the ordinal first sampling time point G1 and the time point PM corresponds to the selected time point farthest in time from the ordinal first sampling time point G1, and the time duration between the time point PM and the first time point (T1) is less than or equal to the time duration of the predetermined sampling interval. By first determining the location of time point G1, which is then used to calculate the location of time point P1, then to calculate the location of time point P2, and so on until the location of time point PM is calculated.

A specific example iteration calculation process will be described further below.

According to the method of estimating the occurrence location of the event of interest in the moving vehicle described with reference to FIG. 2, by estimating the occurrence location of the event of interest based on the plurality of pieces of motion information acquired after the start-up of the motion detection module instead of directly taking the location in the first piece of motion information acquired after the start-up of the motion detection module as the occurrence location of the event of interest, the occurrence location of the event of interest can be determined more accurately while satisfying the requirement of low power consumption of the sensor device, and no other hardware settings need to be additionally set, which is more convenient and cost-effective.

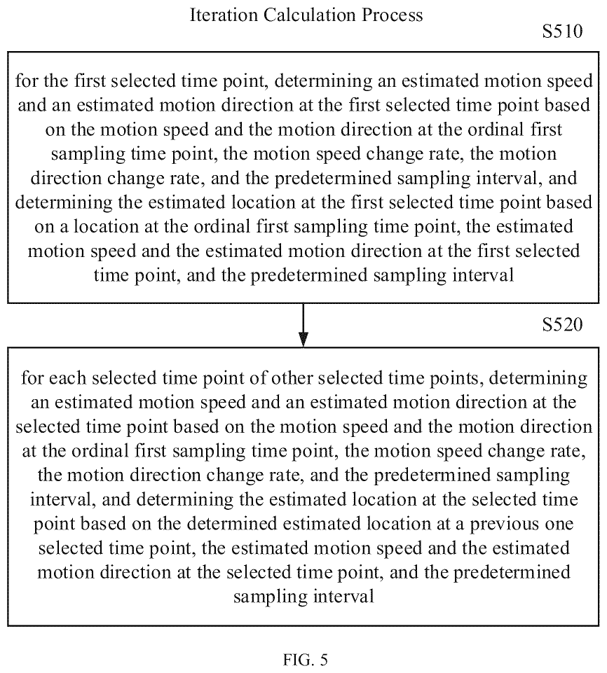

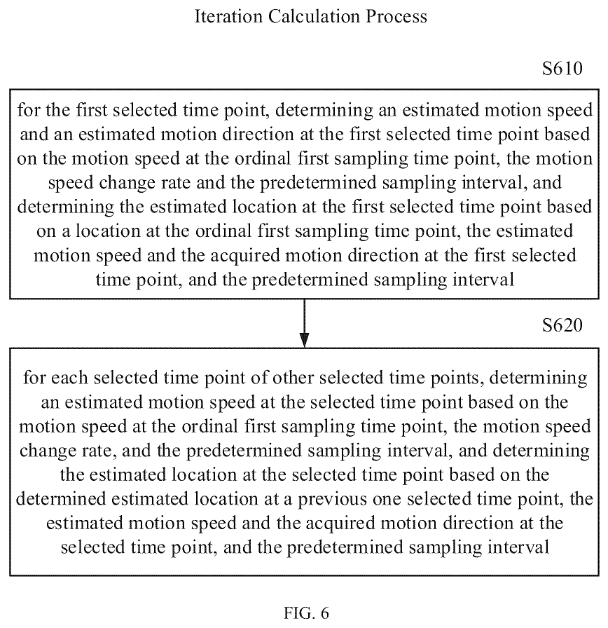

The foregoing iteration calculation process for locations at the plurality of selected time points is exemplarily described below in connection with FIGS. 5 and 6, respectively.

FIG. 5 shows a flow diagram of the iteration calculation process without acquiring the motion direction from the geographic information system. At this time, the motion change rate may include both a motion speed change rate and a motion direction change rate.

As shown in FIG. 5, in step S510, for a selected time point (e.g., point P1 in FIG. 4, also referred to the first selected time point) that is closest in time to the ordinal first sampling time point (e.g., point G1 in FIG. 4), an estimated motion speed and an estimated motion direction at the selected time point closest in time (e.g., point P1 in FIG. 4) may be determined based on the motion speed and the motion direction (V_{GPS1}, O_{GPS1}) at the ordinal first sampling time point (e.g., point G1 in FIG. 4), the motion speed change rate, the motion direction change rate, and the predetermined sampling interval (Tᵢₙₜₑᵣᵥₐₗ), and the estimated location at the selected time point closest in time may be determined based on the location at the ordinal first sampling time point, the estimated motion speed and the estimated motion direction at the selected time point closest in time, and the predetermined sampling interval.

Optionally, the motion speed change rate and the motion direction change rate are respectively determined based on the N motion speeds and N motion directions in the acquired N pieces of motion information, for example, respectively determined using a linear regression algorithm or an average algorithm (including a simple average or a weighted average, etc.). Since during the start-up of the motion detection module, based on the assumption that the motion change rate of the moving vehicle does not change drastically, i.e. remains substantially constant, during the iteration calculation process, the motion speed change rate and the motion direction change rate may be fixed values, respectively denoted as Δᵥ and Δₒ.

In step S520, for each selected time point of other selected time points, based on the motion speed and the motion direction (V_{GPS1}, O_{GPS1}) at the ordinal first sampling time point (e.g., G1 in FIG. 4), the motion speed change rate, the motion direction change rate, and the predetermined sampling interval, an estimated motion speed and an estimated motion direction at the selected time point are determined, and based on the determined estimated location at a latest (previous one) selected time point, the estimated motion speed and the estimated motion direction at the selected time point, and the predetermined sampling interval, an estimated location at the selected time point is determined.

For example, the estimated motion speed at each selected time point Pi may be represented as V_{GPS1-}i*Δᵥ*Tᵢₙₜₑᵣᵥₐₗ, and the estimated motion direction at point Pi may be O_{GPS1-}i*Δₒ*Tᵢₙₜₑᵣᵥₐₗ. The estimated location at point Pi may be derived by determining a travel distance over the predetermined time interval based on the estimated motion speed at point Pi, and both a travel distance in the positive north direction (true north direction) and a travel distance in the positive east direction may be determined based on the estimated motion direction (expressed as an angle relative to the north direction) in addition to the estimated motion speed. For the convenience of calculation, also taking into account that the time period between two adjacent selected points in time is short and the amount of change in speed and direction is not too large, the motion between two selected time points can be regarded as a constant speed motion and the motion direction is constant, however, there is a motion speed change rate and motion direction change rate as described above, so that the amount of change in the estimated motion speed and the estimated motion direction at the point Pi within the predetermined time interval may be corrected in order to satisfy both the accuracy requirement and the complexity requirement of the calculation, and a more accurate estimated location at the point Pi can be obtained based on the corrected estimated motion speed and the corrected estimated motion direction and the predetermined time interval.

For example, the estimated motion speed V_{VPi} at the point Pi is corrected to V_{GPS1}-i*Δ_{V}*Tᵢₙₜₑᵣᵥₐₗ-Δ_{V}*Tᵢₙₜₑᵣᵥₐₗ/2, and the estimated motion direction V_{OPi} at point Pi is corrected to O_{GPS1}-i*Δ₀*Tᵢₙₜₑᵣᵥₐₗ-Δ₀*Tᵢₙₜₑᵣᵥₐₗ/2, the travel distance V_{VP1}*Tᵢₙₜₑᵣᵥₐₗ from point P1 to point G1 can then be calculated. The travel distance is converted to the travel distance in the positive north direction (Y) and the travel distance in the positive east direction (X) according to the estimated motion direction (angle from the positive north direction), so that the location (X_{P1}, Y_{P1}) of the point P1 can be determined.

Alternatively, depending on the type of motion detection module and the reference coordinate system, the location or estimated location referred to herein may be expressed in terms of distance in two axes (e.g., X and Y axes) relative to the origin of the reference coordinate system, the Y axis being the positive north direction, e.g., (Xₑₓₘ, Yₑₓₘ) represents a distance of an absolute value of Xₑₓₘ from the origin on the X axis and a distance of an absolute value of Yₑₓₘ from the origin on the Y axis. Thus, in determining the estimated location at the point Pi, based on the estimated motion speed at the point Pi, the estimated motion direction and the predetermined sampling interval, the travel distances in the positive north direction (Y-axis) and the positive east direction (X-axis) within the predetermined sampling interval are determined to be used together with the location at the ordinal first sampling time point G1 or the already determined estimated location at the previous one selected time point P(i-1), to determine the estimated location at the current selected time point Pi.

In further embodiments, the locations or the estimated location referred to herein are expressed in terms of a longitude and a latitude, and thus, in determining the estimated location at the point Pi, based on the estimated motion speed and the estimated motion direction at the point Pi and the predetermined sampling interval, the travel distances in the latitude direction (positive north direction) and longitude direction (positive east direction) within the predetermined sampling interval are determined and converted into latitude and longitude differences (i.e., angular differences), respectively, to be used together with the location (expressed in latitude and longitude) at the ordinal first sampling time point G1 or the already determined estimated location (expressed in latitude and longitude) at the previous one selected time point P(i-1), to determine the estimated location at the current selected time point Pi.

Furthermore, in calculating the longitude difference, considering that distances or lengths of two longitudes corresponding to different latitudes are different, it is also possible to perform compensation for the longitude difference based on the latitude of the point Pi, which has been calculated based on the latitude difference, to find a more accurate longitude difference (known as cosine compensation). In addition, since the longitude is classified into east and west longitudes, which correspond to 180 degrees, respectively, if the absolute value of the calculated longitude of the estimated location is greater than 180 degrees, it can be converted into the range of 0 degrees to 180 degrees of the east longitude or west longitude. Similarly, the north latitude and the south latitude and the Earth's pole regions may be similarly converted.

FIG. 6 shows a flow diagram of an iteration calculation process in a case where the motion direction is acquired from a geographic information system. This is typically the case where the method for estimating the occurrence location of the event of interest described herein is performed at a computing device external to the sensor device.

At this time, the motion change rate includes only the motion speed change rate, since the motion direction at each selected time point required is available from the geographic information system, and thus the motion direction change rate need not be determined by the computing device.

In this case, in step S610, for a selected time point (e.g., point P1 in FIG. 4) closest in time to the ordinal first sampling time point (e.g., point G1 in FIG. 4, also referred to the first selected time point), an estimated motion speed at the selected time point closest in time (e.g., point P1 in FIG. 4) may be determined based on the motion speed (V_{GPS1}) at the ordinal first sampling time point (e.g., point G1 in FIG. 4), the motion speed change rate, and the predetermined sampling interval (Tᵢₙₜₑᵣᵥₐₗ), and an estimated location at the selected time point closest in time may be determined based on the location at the ordinal first sampling time point, the estimated motion speed and the acquired motion direction (i.e., acquired from the geographic information system) at the selected time point closest in time and the predetermined sampling interval.

In step S620, for each selected time point of the other selected time points, the estimated motion speed at the selected time point may be determined based on the motion speed (V_{GPS1}) at the ordinal first sampling time point (e.g., G1 in FIG. 4), the motion speed change rate, the motion direction change rate, and the predetermined sampling interval, and the estimated location at the selected time point may be determined based on the determined estimated location at the previous one selected time point, the estimated motion speed and the acquired motion direction (acquired from the geographic information system) at the selected time point, and the predetermined sampling interval.

Steps S610-S620 are similar to steps S510-S520, except that in steps S510-S520 it is necessary to calculate the estimated motion direction at each selected time point, and steps S610-S620 do not need to calculate the estimated motion direction, but instead directly utilize the motion direction at each selected time point acquired from the geographic information system. Therefore, the description is not repeated here.

In the case shown in FIG. 6, although the motion direction is not corrected as in the case shown in FIG. 5, the motion direction at each selected sampling point acquired from the geographic information system is directly utilized, considering that the predetermined time interval between every two adjacent selected time points is small, the direction change within this interval is small, so that even if it is directly used to calculate differences in the positive north direction as well as the positive east direction, the error is small and also within an acceptable range.

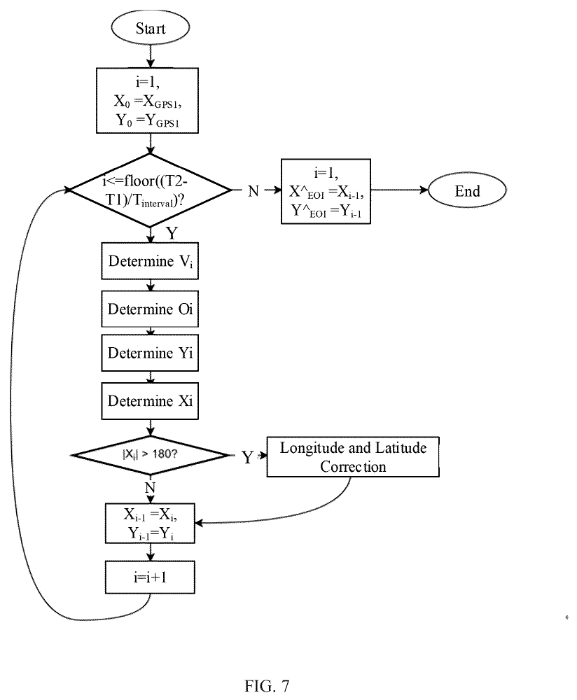

The iteration calculation process is described above with reference to FIG. 5 and FIG. 6, and an algorithmic flow diagram of the iteration calculation process is schematically described below in connection with FIG. 7.

In FIG. 7, i denotes the number of iteration calculations, and for the i-th iteration calculation (i.e., the location calculation for the selected time point Pi as described above), the estimated location obtained from the previous one ((i-1)-th) iteration is used, and if M iterations have been performed, the estimated location obtained from the last one M-th iteration can be used as the occurrence location of the event of interest.

Specifically, as shown in FIG. 7, i is first assigned as 1, and the location at the ordinal first sampling time point G1 is used as the location initial value (X₀=X_{GPS1}, Y₀=Y_{GPS1}) of the first iteration calculation. Then, it is determined whether the current value of i is equal to or less than M (i.e., floor (T₂-T₁)/Tᵢₙₜₑᵣᵥₐₗ), and if so, it is also necessary to continue the iteration, and if not, it indicates that the location of the last one (M-th) selected time point has been determined, i.e., the location of the M-th selected time point can be taken as the occurrence location of the event of interest.

During the first iteration, the estimated motion speed Vpl at the first selected time point is determined, as described earlier, for example based on the motion speed at the ordinal first sampling time point G1, the motion speed change rate and the predetermined time interval, as described with reference to earlier.

Then, the estimated motion direction Opl at the first selected time point may be determined, or the motion direction at the first selected time point is acquired from the geographic information system. For example, the estimated motion direction at the first selected time point may be determined based on the motion direction at the ordinal first sampling time point G1, the motion direction change rate and the predetermined time interval as described with reference to the foregoing.

Next, the location at the first selected time point may be determined, for example, based on the location at the ordinal first sampling time point G1, the estimated motion speed, and the predetermined time interval. The location may be expressed in terms of a latitude and a longitude as an example, and thus may include determining a location in the latitude direction as well as a location in the longitude direction, represented as (X₁, Y₁). For example, the latitude or longitude of the location at the first selected time point may be determined further based on the estimated motion direction/the acquired motion direction. Optionally, cosine compensation and longitude value correction may also be employed when calculating the longitude, as previously described.

After the location at the first selected time point is obtained, the determined location is taken as the location initial value of the second iteration calculation for the second selected time point, i.e. (X₀=X₁, Y₀=Y₁), then i is assigned to be i+1, i.e. i is assigned to be 2, then it is determined whether the current value of i is less than or equal to M (i.e. floor (T2-T1)/Tᵢₙₜₑᵣᵥₐₗ), and if so, the above process of determining the estimated motion direction (if any), the estimated motion speed and the location is continued to be repeated; if not, the location of the M-th (i.e., (i-1)-th, currently i=M+1) selected time point is taken as the occurrence location of the event of interest.

Through the iteration calculation process described with reference to FIGS. 5-7, the processing module or the computing device, after acquiring various information or data, can calculate an estimated location at which the moving vehicle is located at a time point closest to the first time point at which the event of interest occurs, and can take it as the occurrence location at which the event of interest occurs, which is relatively simple without the need for additional hardware circuits.

According to another aspect of the present application, a computing device is also provided. The computing device may be a computing device as shown in FIG. 1B (e.g., a local computing device or a cloud computing device).

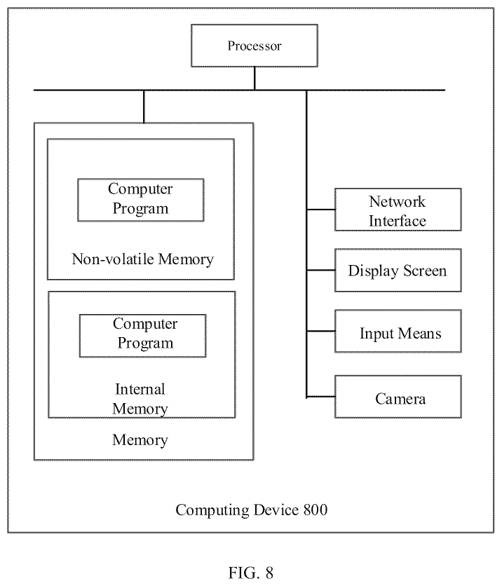

FIG. 8 illustrates a block diagram of a computing device according to an embodiment of the present application.

As shown in FIG. 8, the computing device 800 may include one or more processors and one or more memories.

By way of example, the processor(s), and the memory (ies) may be connected by a system bus, and the computing device of the present application may also include a network interface, an input means, and a display screen, among others. The memory (ies) may comprise a non-volatile storage medium and an internal memory. The non-volatile storage medium of the computing device stores an operating system and may also store a computer (executable) program that, when executed by the processor(s), causes the processor(s) to implement various operations performed by the computing device as described above. The internal memory may also have stored therein a computer-executable program that, when executed by the processor(s), causes the processor to implement various operations performed by the computing device as previously described.

The processor(s) may be an integrated circuit chip having signal processing capabilities. The processor described above may be a general purpose processor, a digital signal processor (DSP), an application specific integrated circuit (ASIC), an off-the-shelf programmable gate array (FPGA) or other programmable logic device, discrete gate or transistor logic, discrete hardware components for implementing or performing the disclosed methods, steps and logical block diagrams in the embodiments of the present application. The general-purpose processor may be a microprocessor or the processor may be any conventional processor or the like and may be of an X84 architecture or an ARM architecture.

The non-volatile memory may be a read-only memory (ROM), a programmable read-only memory (PROM), an erasable programmable read-only memory (EPROM), an electrically erasable programmable read-only memory (EEPROM), or a flash memory. It should be noted that the memory (ies) described herein is intended to comprise, without being limited to, these and any other suitable classes of memory (ies).

The display screen may be a liquid crystal display screen or an electronic ink display screen, and the input means of the computer device may be a touch layer overlaid on the display screen, a button, a trackball or a trackpad provided on the housing of the computing device, an external keyboard, trackpad or mouse, or the like.

It is noted that the flowchart and block diagrams in the drawings illustrate the architecture, functionality, and operation of possible implementations of the method and apparatus according to various embodiments of the present application. In this regard, each block in the flowchart or block diagrams may represent a module, segment, or a portion of code, which comprises at least one executable instruction for implementing the specified logical function(s). It should also be noted that, in some alternative implementations, the functions noted in the block may occur out of the order noted in the drawings. For example, two blocks shown in succession may, in fact, be executed substantially concurrently, or the blocks may sometimes be executed in a reverse order, depending upon the functionality involved. It will also be noted that each block of the block diagrams and/or flowchart illustration, and combinations of blocks in the block diagrams and/or flowchart illustration, or individual modules mentioned, can be implemented by a special purpose hardware-based system that performs the specified functions or operations, or by a combination of special purpose hardware and computer instructions.

The embodiments of the present application as described in detail above are merely illustrative, but not limiting. It should be understood by those skilled in the art that various modifications and combinations of these embodiments or features thereof may be made without departing from the principles and spirit of the present application, such modifications shall fall within the scope of the present application.

What is claimed is:

1. A method for estimating an occurrence location of an event of interest in a moving vehicle, comprising:
determining a location determination delay time period based on a first time point at which the event of interest occurs and a second time point at which motion information is acquired earliest;
acquiring a plurality of pieces of motion information at a plurality of sampling time points with a predetermined sampling interval, wherein each piece of motion information comprises a motion speed, a motion direction, and a location of the moving vehicle at a respective sampling time point;
determining a motion change rate of the moving vehicle based on the plurality of pieces of motion information; and
estimating the occurrence location of the event of interest based on the motion information at an ordinal first one sampling time point of the plurality of sampling time points, the motion change rate, and the location determination delay time period.

2. The method of claim 1, wherein estimating the occurrence location of the event of interest comprises:
determining a plurality of selected time points that are within the location determination delay time period based on the predetermined sampling interval;
iteratively determining an estimated location at each selected time point of the plurality of selected time points, starting with a selected time point, of the plurality of selected time points, that is closest in time to the ordinal first sampling time point and based on the motion information at the ordinal first sampling time point, the motion change rate and the predetermined sampling interval; and
taking the estimated location at the selected time point of the plurality of selected time points that is farthest in time from the ordinal first sampling time point as the estimated occurrence location of the event of interest.

3. The method of claim 2, wherein the motion change rate comprises a motion speed change rate and a motion direction change rate,
wherein iteratively determining an estimated location at each selected time point of the plurality of selected time points comprises:
for the selected time point closest in time, determining an estimated motion speed and an estimated motion direction at the selected time point closest in time based on the motion speed and the motion direction at the ordinal first sampling time point, the motion speed change rate, the motion direction change rate, and the predetermined sampling interval, and determining the estimated location at the selected time point closest in time based on the location at the ordinal first sampling time point, the estimated motion speed and the estimated motion direction at the selected time point closest in time, and the predetermined sampling interval; and
for each selected time point of other selected time points, determining an estimated motion speed and an estimated motion direction at the selected time point based on the motion speed and the motion direction at the ordinal first sampling time point, the motion speed change rate, the motion direction change rate, and the predetermined sampling interval, and determining the estimated location at the selected time point based on the determined estimated location at a previous one selected time point, the estimated motion speed and the estimated motion direction at the selected time point and the predetermined sampling interval.

4. The method as claimed in claim 2, wherein the motion change rate comprises a motion speed change rate, and a motion direction at each selected time point is acquired from a geographic information system,
wherein iteratively determining the estimated location at each selected time point comprises:
for the selected time point closest in time, determining an estimated motion speed at the selected time point closest in time based on the motion speed at the ordinal first sampling time point, the motion speed change rate and the predetermined sampling interval, and determining the estimated location at the selected time point closest in time based on the location at the ordinal first sampling time point, the estimated motion speed and the motion direction at the selected time point closest in time, and the predetermined sampling interval; and
for each selected time point of other selected time points, determining an estimated motion speed at the selected time point based on the motion speed at the ordinal first sampling time point, the motion speed change rate, and the predetermined sampling interval, and determining the estimated location at the selected time point based on the determined estimated location at a previous one selected time point, the estimated motion speed and the acquired motion direction at the selected time point and the predetermined sampling interval.

5. The method of claim 3, wherein each location or each estimated location is expressed in a longitude and a latitude,
wherein for each selected time point of the plurality of selected time points, determining the estimated location at the selected time point comprises: determining travel distances in latitude and longitude directions over the predetermined sampling interval based on the estimated motion speed and the estimated motion direction at the selected time point and the predetermined sampling interval, and converting the travel distances into a latitude difference and a longitude difference, respectively, to be used together with the location at the ordinal first sampling time point or the estimated location at the previous one selected time point for determining the estimated location at the selected time point.

6. The method of claim 1, wherein acquiring a plurality of pieces of motion information at a plurality of sampling time points with a predetermined sampling interval comprises:
acquiring a motion speed, a motion direction and a location of the moving vehicle at each of the plurality of sampling time points from a motion detection module arranged in a sensor device in the moving vehicle; or
acquiring a motion speed and a location of the moving vehicle at each of the plurality of sampling time points from the motion detection module, and acquiring a motion direction of the moving vehicle at each of the plurality of sampling time points from a geographic information system.

7. The method of claim 1, wherein the motion change rate comprises a motion speed change rate and/or a motion direction change rate;
wherein determining the motion change rate of the moving vehicle based on the plurality of pieces of motion information comprises:
operating, using a linear regression algorithm or an average algorithm, a plurality of motion speeds and/or a plurality of motion directions included in the plurality of pieces of motion information, respectively, to obtain the motion speed change rate and/or the motion direction change rate.

8. The method of claim 1, wherein the method is performed at a sensor device in the moving vehicle, or in the cloud.

9. The method of claim 5, wherein the method is performed at a sensor device in the moving vehicle, or in the cloud.

10. An apparatus for estimating an occurrence location of an event of interest in a moving vehicle, comprising:
a sensing module for sensing data related to the event of interest in a low power consumption mode and sending an indication to a processing module when the event of interest is sensed;
a motion detection module for sampling motion information of the moving vehicle at a predetermined time interval after start-up is completed; and
a processing module for determining a first time point at which the event of interest occurs based on the indication, starting up the motion detection module and acquiring the motion information from the motion detection module in response to determining that the event of interest occurs, and determining a second time point at which the motion information is acquired earliest,
wherein the processing module is further configured to perform the method of claim 1.

11. An apparatus for estimating an occurrence location of an event of interest in a moving vehicle, comprising:
a sensing module for sensing data related to the event of interest in a low power consumption mode and sending an indication to a processing module when the event of interest is sensed;
a motion detection module for sampling motion information of the moving vehicle at a predetermined time interval after start-up is completed; and
a processing module for determining a first time point at which the event of interest occurs based on the indication, starting up the motion detection module and acquiring the motion information from the motion detection module in response to determining that the event of interest occurs, and determining a second time point at which the motion information is acquired earliest,
wherein the processing module is further configured to perform the method of claim 9.

12. A computing device, comprising:
a processor; and
a memory having stored thereon a computer program which, when executed by the processor, causes the processor to carry out the method according to claim 1.

13. A computing device, comprising:
a processor; and
a memory having stored thereon a computer program which, when executed by the processor, causes the processor to carry out the method according to claim 9.
